(19) United States
(12) Patent Application Publication
(10) Pub. No.: US 2016/0081770 A1
(43) Pub. Date: Mar. 24, 2016

(54) ABUTMENT HAVING A CORE

(71) Applicant: Straumann Holding AG, Basel (CH)

(72) Inventor: Arik Zucker, Zurich (CH)

(21) Appl. No.: 14/950,140

(22) Filed: Nov. 24, 2015

Related U.S. Application Data
(63) Continuation of application No. 12/558,903, filed on Sep. 14, 2009.

(30) Foreign Application Priority Data
Sep. 16, 2008 (EP) 08016255.5

(51) Int. Cl. A61C 8/00

(52) U.S. Cl. CPC A61C 8/0015; A61C 8/0056; A61C 8/0053; A61C 8/0068

(57) ABSTRACT

Abutment (5) for a two-part dental implant for receiving an element that is to be applied, the abutment (5) having at least one core (75) and a cover layer (70). The at least one core (75) and the cover layer (70) are visually and/or acoustically distinct from each other.

### FIELD OF THE INVENTION

The present invention relates to an abutment for a two-part dental implant.

### BACKGROUND

Two-part dental implants are in widespread use. In a first step, an anchoring part is first implanted, onto which an abutment is later mounted. An element to be applied, for example a crown, bridge or prosthesis structure, is mounted in turn onto the abutment.

In the simplest form, a straight, conical abutment has at the very bottom a threaded pin which is screwed into an inner threaded bore present in the implant. A conical root portion of the abutment then sits in the conical receiving bore of the implant, and a head part of the abutment protrudes above the implant shoulder.

However, because of the features of the jaw, or because of a hole being drilled at an angle in the jaw, it may also be necessary to fit an angled abutment.

Even after satisfactory implantation of an implant, it is inevitable that corrections of a greater or lesser degree will have to be made by grinding the abutment, so as to ensure that the prosthetic element(s) mounted thereon fit properly. The grinding of the abutment can, however, have the effect that said abutment becomes too thin in places, which is difficult for the dentist to discern visually. Consequently, the overall stability is no longer guaranteed, and this may lead to a fracture when a load is applied.

### SUMMARY OF THE INVENTION

An object of the present invention is to make available a warning system which shows the dentist that further grinding of the abutment could lead to a fracture when a load is applied.

According to one embodiment of the present invention an abutment is provided for a two-part implant. The abutment serves to receive a further element that is to be applied, for example, an intermediate piece or a crown, bridge or prosthesis structure. The abutment has at least one core and a cover layer, the at least one core and the cover layer being visually and/or acoustically distinct from each other. The at least one core is the part of the abutment that is needed as a minimum in order to ensure sufficient stability of the implant. The minimum dimension of the core depends on the indication, the material and the processing. By contrast, in terms of the stability of the implant, the cover layer represents an optional layer which, if appropriate, can be completely ground away. Ideally, the thickness of the cover layer is chosen such that the least amount of material has to be ground away in a standard implantation, so as to ensure that patient visits are not unnecessarily protracted. By virtue of the fact that the at least one core and the cover layer are visually and/or acoustically distinguishable from each other, the dentist is using an abutment with an integrated warning system that shows him, while he is grinding the abutment, that the stability would no longer be guaranteed upon further grinding.

There are various possible ways of ensuring that the cover layer can be visually distinguished from the at least one core. The term “visually” is to be understood as meaning that the difference between the cover layer and the at least one core can be discerned by the naked eye. This can, for example, involve a different color or a different shade.

By way of example, the at least one core can contain coloring pigments that are not present in the cover layer or are present in a different quantity therein. Such coloring pigments are preferably chosen from the group including iron oxide (Fe₂O3), iron nitrate (Fe(NO₃)₃), bismuth oxide (Bi₂O₃), cerium oxide (CeO₂), yttrium oxide (Y₂O₃), erbium oxide (Er₂O₃), praseodymium oxide (Pr₆O₁₁), praseodymium nitrate (Pr(NO₃)₃), zinc oxide (ZnO), vanadium oxysulfate (VOSO₄), and mixtures thereof. For the at least one core, it is additionally possible to use metallic copper nanoparticles, at any rate in a mixture with one or more of the above-mentioned pigments. In a particularly preferred embodiment, the at least one core contains 0.01 to 0.2 mol % and the cover layer 0.01 to 0.2 mol % of the above coloring pigments. The concentration of the coloring pigments depends not only on the coloring pigment as such, but also on the sintering temperature, since, as is shown in FIG. 8, the yellow/blue proportion or green/red proportion varies depending on the sintering temperature (the b* value corresponds to the yellow/ blue proportion, where a low value corresponds to a high blue proportion and a high value corresponds to a high yellow proportion; the a* value corresponds to the green/red proportion, where a low or negative value corresponds to a high green proportion and a high value corresponds to a high red proportion).

Alternatively, it is possible for the at least one core to be distinguished acoustically from the cover layer. The term “acoustically” is understood as meaning that the sound of the drill during the grinding of the abutment differs depending on whether the at least one core or the cover layer is being ground, the difference being so distinct that it can be immediately perceived by the dentist. The perceivable acoustic difference is produced by means of the at least one core having a hardness that differs from the cover layer. As soon as the drill strikes the harder material, the perceivable sound is louder than before.

The material used for the cover layer is preferably aluminum oxide (Al₂O₃). Aluminum oxide is a transparent ceramic and, for esthetic reasons, is therefore suitable for the cover layer. The material used for the at least one core is preferably partially stabilized tetragonal zirconia polycrystal (TZP), in particular yttrium-stabilized TZP (Y-TZP). This material is characterized by optimal behavior in respect of hardness and fracture stability, which is of course particularly important for the core.

In a particularly preferred embodiment, the at least one core and the cover layer differ from each other both visually and acoustically, i.e. the dentist is provided with a dual warning system. This can be achieved, for example, by adding coloring pigments and strengthening the core material.

Either a straight or an angled abutment can be produced by grinding the abutment. For a straight abutment, it is preferable to use an abutment according to the invention with exactly one core and a cover layer. An intermediate layer can optionally lie between the exactly one core and the cover layer.

In another preferred embodiment, the abutment according to the invention contains three or more cores and a cover layer that are visually distinguishable from one another. That is to say, the at least three cores all have different colors or shades of color and additionally differ from the cover layer. Angled abutments are preferably produced with such an abutment. The abutment according to this preferred embodiment now permits maximum screwing precision since the dentist grinds the corresponding attachment part in situ in the mouth. The three predetermined cores provide the dentist with clear indications of how far he is able to grind. These three or more cores are preferably arranged facing away from the center axis by an angle of inclination of 5° to 25°. In a preferred embodiment, the angle of inclination is 15°. An opening with or without a thread can optionally be arranged centrally between the cores in order to secure a crown, bridge or prosthesis structure thereon.

The abutment according to the invention is preferably made of a biocompatible ceramic. The biocompatible ceramic is preferably a stabilized zirconia ceramic, particularly preferably 92.1 to 93.5% by weight of ZrO₂ and 4.5 to 5.5% by weight of Y₂O₃ and 1.8 to 2.2% by weight of HfO₂. A stabilized zirconia ceramic of this kind has extraordinarily high mechanical stability and strength, particularly when produced by hot isostatic pressing or by sintering with subsequent hot isostatic redensification. The cover layer can be injected onto the at least one core, which differs visually and/or acoustically from the cover layer, and the green body thereby produced can be sintered.

In another preferred embodiment, an intermediate layer is arranged between the at least one core and the cover layer and has the function of a transition layer. That is to say, it either has a color different than the cover layer and the at least one core or it has a hardness that lies between the hardness of the cover layer and the hardness of the at least one core.

The implant (base body implanted in the bone) onto which the abutment according to the invention is mounted can be made of metal or a metal alloy, or of a ceramic. In the case of a metal, the implant is preferably made of titanium or a titanium alloy. The implant is pretreated by suitable removal of material or by suitable coating of its outer surface in order to achieve good osteogenesis after the implantation. For example, the surface of the anchoring part can be silanized or hydroxylated. It is particularly preferably roughened, by a method involving removal of material, and etched with hydrofluoric acid. The implant thus has a surface structure as described in EP 07 007 950.4, to which reference is made.

According to another embodiment, a method of producing an abutment is provided wherein a green body of an abutment is injected with the at least one core, which at least one core contains for example, a coloring pigment, and a cover layer is injected onto the at least one core and then sintered.

### BRIEF DESCRIPTION OF THE DRAWINGS

Further features and advantages will become clear from the following description of preferred illustrative embodiments and by reference to the drawings, in which:

FIG. 1 shows a plan view of a first embodiment of the abutment according to the invention;

FIG. 2 shows a section through the abutment according to the invention shown in FIG. 1;

FIG. 3 shows a first embodiment of the abutment according to the invention with an attached prosthesis;

FIG. 4 shows a second embodiment of the abutment according to the invention;

FIG. 5 shows a section through the abutment according to the invention shown in FIG. 4;

FIG. 6 shows a second embodiment of the abutment according to the invention after the grinding operation;

FIG. 7 shows a second embodiment of the abutment according to the invention with an attached prosthesis; and

FIG. 8 shows the dependency of the coloring pigments on the sintering temperature.

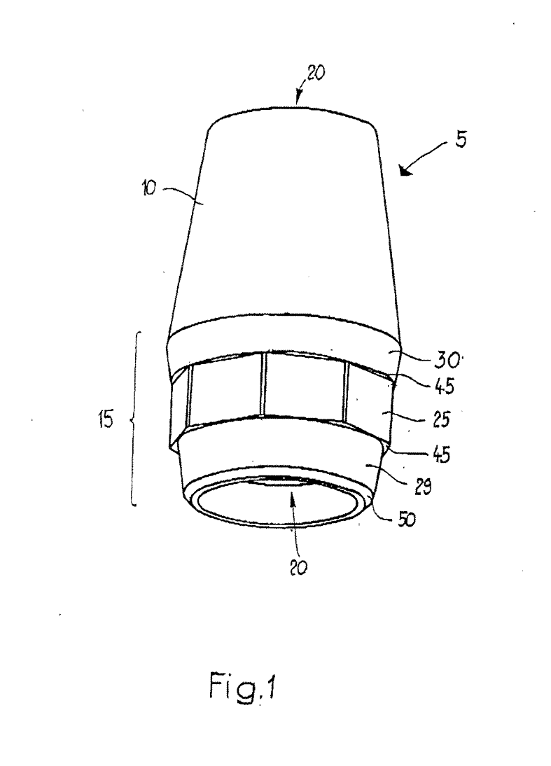

A plan view of a first embodiment of the abutment 5 according to the invention is shown in FIG. 1. The abutment 5 has a neck portion 10 at the top and, below this, a cone portion 15. An inlet 20, here in the form of an axial passage, extends through the abutment 5. The neck portion 10 can have a vertically extending plane surface with which the prosthesis element later to be applied to the abutment 5 is secured in terms of rotation. At the same time, the plane surface can be used for engagement of a screwing tool. In an advantageous variant, it is possible for three plane surfaces to be arranged offset by 120°.

The cone portion 15 has a mating contour 25 that complements the receiving contour located in the implant, such that the abutment 5 can be inserted in a rotationally secured manner in the implant. Analogously to the recessed polygon formed as receiving contour, the mating contour 25 is designed as a polygon in this example. The mating contour 25 is arranged on the cone portion 15 in such a way that segments 29, 30 which are free of interruptions are also provided on the cone portion 15. The jacket surfaces of both segments 29, 30 are flush with one another, in the same way as the portions of the inner cone in the implant head of the implant base body (not shown) are also flush with one another. Shoulders 45 are formed at the transitions from the segment 29 to the mating contour 25 and from the latter to the segment 30. At the very bottom, the abutment 5 and its segment end at the rim 50. It is also possible to arrange the mating contour 25 directly adjacent to the rim.

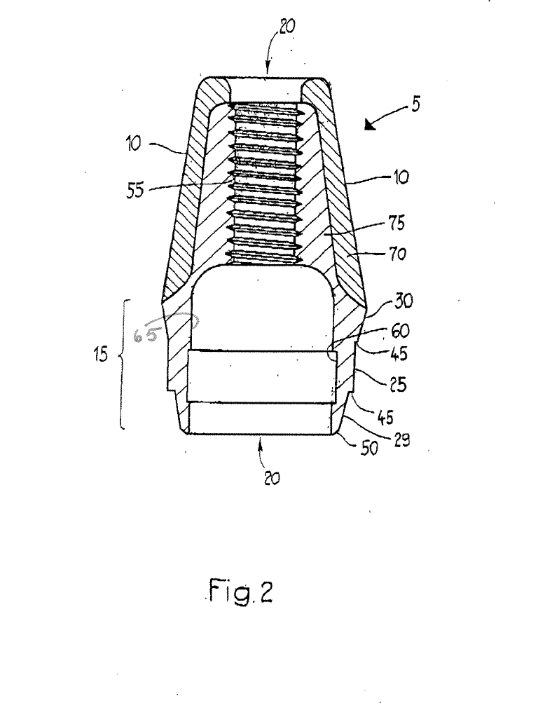

FIG. 2 shows a section through the abutment 5 depicted in FIG. 1. An inner thread portion 55 can be provided inside the inlet 20, starting at the top thereof, and a radially encircling groove 60 is present before the lower mouth of the inlet 20. The optional inner thread portion 55 would serve to receive an occlusal screw with which the superstructure could be secured. The threaded pin of the occlusal screw extends only partially into the inlet 20. A threadless screw-head portion 65 remains between the inner thread portion 55 and the groove 60. In this embodiment, the abutment 5 according to the invention has a core 75 and a cover layer 70 that are visually and/or acoustically distinct from each other. This gives the dentist the possibility of grinding the abutment 5 without having to worry about the stability of the implant no longer being guaranteed after the grinding of the abutment 5, since the change in color, or the perceivable acoustic change in the drilling sound, tells him when he should stop grinding.

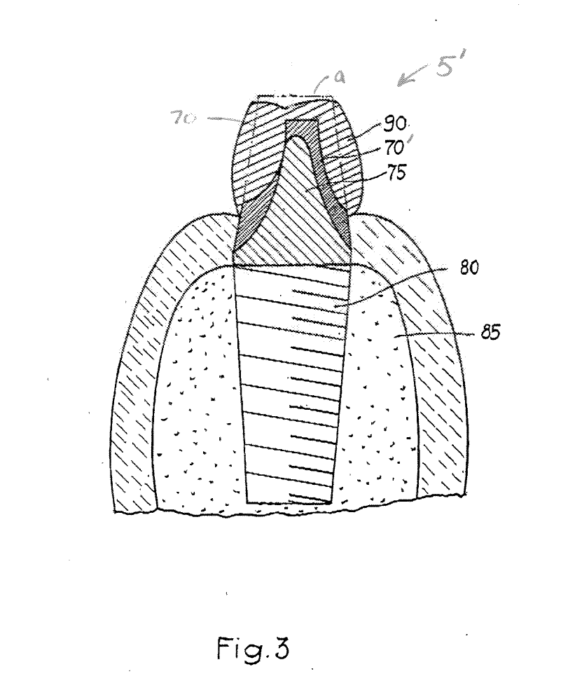

FIG. 3 shows a section through the first embodiment of the abutment 5′ according to the invention, which has been secured on an implant base body 80 implanted in the jaw and ground. The implant 80 is implanted in the bone tissue 85. The original shape of the abutment cover layer 70 is still indicated by a broken line a. The remaining ground abutment cover layer 70′ corresponds to the individual requirements of the patient and ensures optimal stability of the implant. The core 75, which differs visually or acoustically from the cover layer 70′, has not been ground. The ground abutment 5′ has been provided with a crown 90.

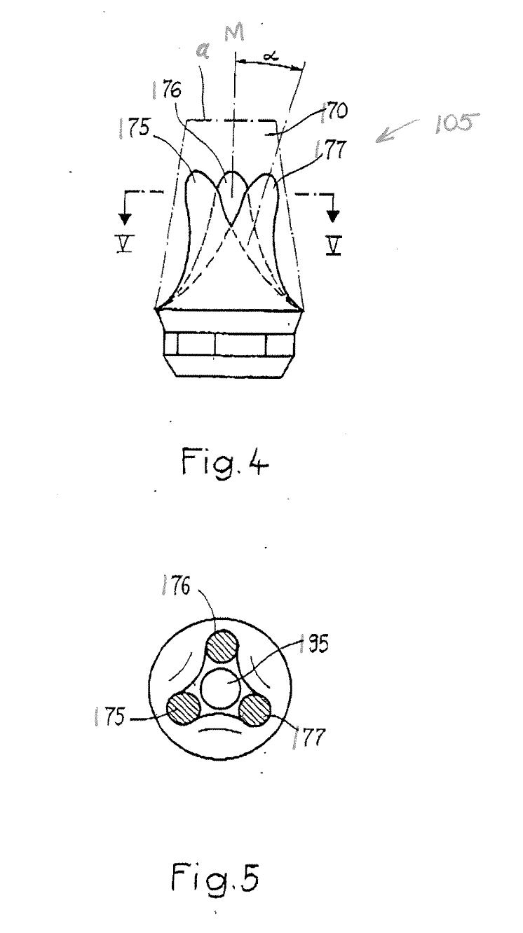

FIG. 4 shows a second embodiment of the abutment 105 according to the invention. The abutment 105 has three cores 175, 176, 177 and a cover layer 170, and an intermediate layer can optionally be arranged between the cores 175, 176, 177 and the cover layer 170. The three cores 175, 176, 177 of the abutment are rotationally symmetrical with respect to a longitudinal center or mid-axis M and are arranged at an angle of inclination α of 5 to 25°. An angle of inclination α of 15° is particularly preferable.

Between the cores 175, 176, 177, an opening 195 can be arranged which serves for securing a prosthetic element.

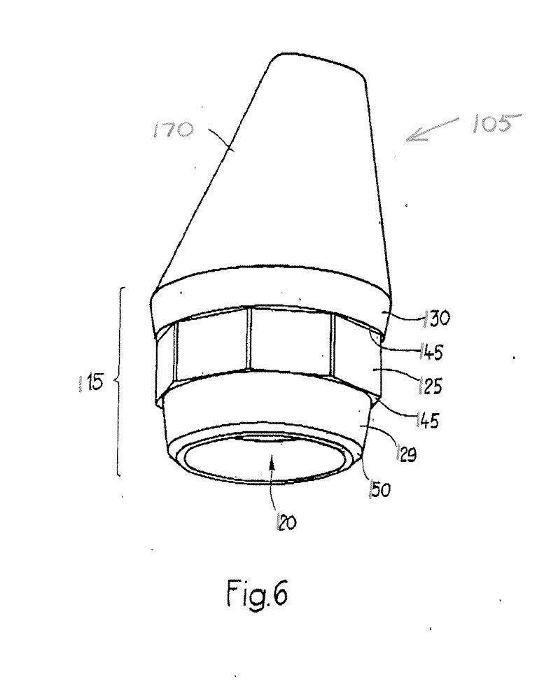

FIG. 5 shows a section through the abutment 105 of FIG. 4 in order to better illustrate the three cores 175, 176, 177. The three cores 175, 176, 177 allow a dentist to grind an angled abutment in the event of a problematic jaw situation, for example when a jaw bone is angled in relation to the cutting surface of the teeth. He is able to do this without having to retain the 360° angle otherwise necessary in prefabricated angled abutments for bringing the abutment into the correct position. Such an abutment 105′ after the corresponding grinding, is shown in FIG. 6. In the center between the cores 175, 176, 177, an opening 195 can be arranged which serves for securing the prosthetic elements. In FIG. 6, the portions of the abutment corresponding to those of the first embodiment have been identified with a corresponding “100” series number (e.g., 115 in the second embodiment corresponds to 15 in the first embodiment).

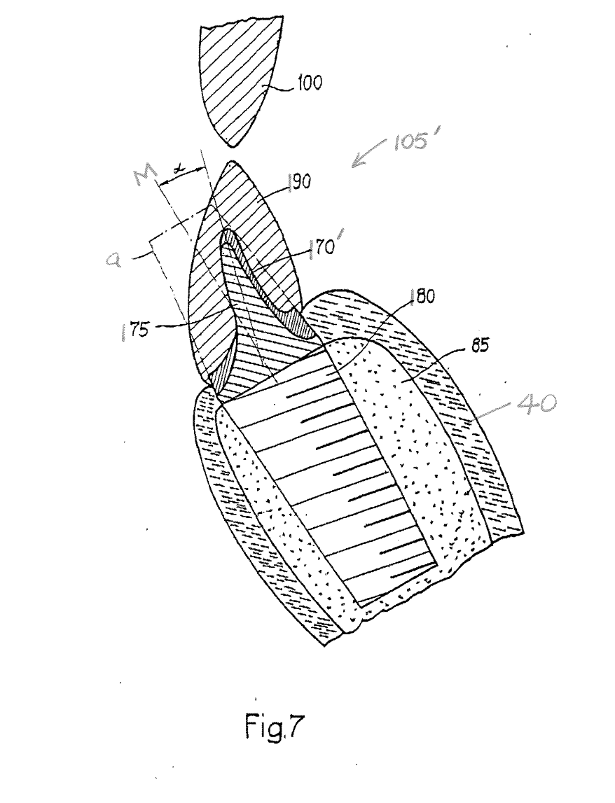

FIG. 7 shows a section through the second embodiment of the abutment 105′ according to the invention which has been secured on an implant 180 implanted in the jaw. The implant 180 is implanted in the bone tissue 85; soft tissue 40 surrounds the bone tissue 85. The original shape of the abutment cover layer 170 is still indicated by a broken line a. The ground, angled abutment 105′ corresponds to the individual requirements of the patient and ensures optimal stability of the implant. The core 175, which differs visually or acoustically from the cover layer 170, has not been ground. The ground abutment 105′ has been provided with a crown 190. By virtue of the abutment 105 according to the invention, it is possible, despite the angled jaw bone, and while maintaining stability, to align the crown 190 precisely with respect to the opposing tooth 100, which is a prerequisite for an optimal bite.

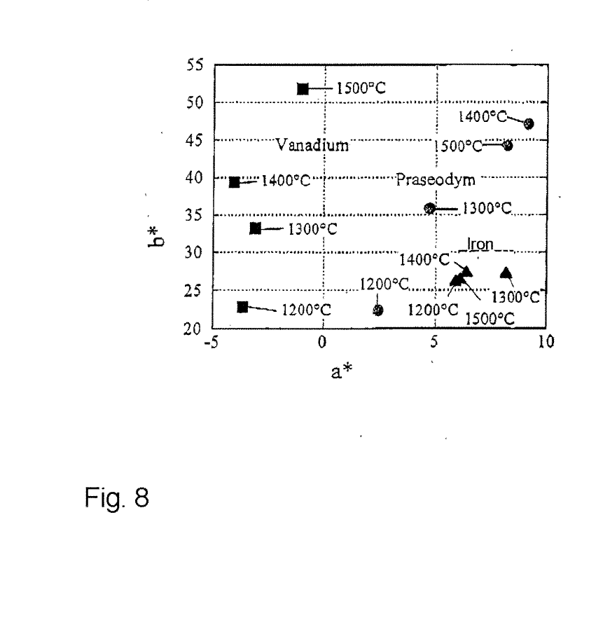

FIG. 8 shows the dependence of various coloring pigments on the sintering temperature, as may be used in various embodiments of the invention previously disclosed.

1-22. (canceled)

23. A method comprising:
providing a ceramic abutment of a two-part dental implant for receiving an element to be applied, the abutment comprising:
at least one core having an upper end, and
a cover layer that extends over said upper end of the at least one core,
the at least one core being configured to guarantee stability of the abutment while the cover layer is completely removable by grinding without loss of stability,
wherein the entire of the at least one core and the entire cover layer are visually and/or acoustically different from one another for detection visually and/or acoustically during grinding, and
the method comprising implanting, the implant, including the step of:
grinding the cover layer of the abutment to correspond to the individual requirements of a patient, while observing the cover layer, and using the visually and/or acoustically different core and cover layer as an integrated warning system to prevent grinding of the core.

24. The method of claim 23, further comprising:
selecting a thickness of the cover layer in accordance with a standard implantation.

25. The method of claim 23, wherein the grinding is carried out to ensure that an element placed on the ground implant fits properly, the element comprising an intermediate piece, crown, bridge, or prosthetic element.

26. The method of claim 23, wherein the visually different cover layer and core are of a different color or a different color shade.

27. The method of claim 23, wherein one or more of the visually different cover layer and core contain coloring pigments.

28. The method of claim 27, wherein the visually different cover layer and core are produced by selecting a quantity of coloring pigments and a sintering temperature for sintering of the cover layer and core.

29. The method of claim 23, wherein the abutment comprises a straight abutment, with exactly one core having the cover layer.

30. The method of claim 23, wherein the abutment comprises an angled abutment, having three or more cores, each core having the cover layer.

31. The method of claim 30, wherein the three or more cores and the cover layer are visually distinguishable from one another.

32. The method of claim 30, wherein the three or more cores all have different colors or different color shades, which all differ from the cover layer.

33. The method of claim 30, wherein the three or more cores all have the same color which is different from that of the cover layer.

34. The method of claim 23, wherein the abutment has a vertically extending plane surface with which the element can be applied in terms of rotation.

35. The method of claim 23, further comprising the step of:
applying the element to the ground abutment.

36. The method of claim 35, wherein the applying step comprises screwing the element on the ground abutment.

37. The method of claim 35, wherein the abutment has an opening for securing the element to the ground abutment, and the applying step comprises securing the element on the ground abutment.

38. The method of claim 23, wherein the two-part dental implant includes an implant base body implanted in bone tissue with soft tissue surrounding the bone tissue, with the cover layer visible above the soft tissue.

39. The method of claim 38, wherein the implant base body has a longitudinal center axis of rotation and the abutment includes a plurality of cores arranged symmetrically about the axis and at an angle of inclination of 5-25° with respect to the axis, wherein the implant base body is installed in a jaw bone angled in relation to a cutting of surface of a patient's teeth.

40. The method of claim 38, wherein the element is a crown and is applied to the ground abutment aligned with an opposing tooth of the patient's jaw bone.

41. The method of claim 23, wherein an intermediate layer is arranged between the at least one core and the cover layer and is visually different from the at least one core and the cover layer.

42. The method of claim 38, wherein the implant base body is made of metal, metal alloy or a ceramic.

43. The method of claim 23, wherein the abutment has three cores arranged symmetrically around a central longitudinal axis of the abutment.

44. The method of claim 43, wherein the three cores are arranged facing away from the central longitudinal axis at an angle of inclination of 5 to 25°.

45. The method of claim 44, wherein the angle of inclination is 15°.

46. The method of claim 23, wherein the implant has a plurality of cores that differ visually and/or acoustically from one another.

47. The method of claim 23, wherein the at least one core contains a coloring pigment selected from the group consisting of iron oxide, iron nitrate, bismuth oxide, cerium oxide, yttrium oxide, erbium oxide, praseodymium oxide, praseodymium nitrate, zinc oxide, vanadium oxysulfate, metallic copper nanoparticles and mixtures thereof.

48. The method of claim 23, wherein the cover layer contains a coloring pigment selected from the group consisting of iron oxide, iron nitrate, bismuth oxide, cerium oxide, yttrium oxide, erbium oxide, praseodymium oxide, praseodymium nitrate, zinc oxide, vanadium oxysulfate and mixtures thereof.

49. The method of claim 23, wherein the cover layer is aluminum oxide.

50. The method of claim 23, wherein the at least one core is yttrium-stabilized polycrystalline tetragonal zirconia polycrystal.

51. The method of claim 23, wherein the providing step comprises providing a green body abutment that is injected with the at least one core, the at least one core containing a coloring pigment, and the cover layer is injected onto the at least one core and then sintered.

52. The method of claim 23, wherein the at least one core contains 0.01 to 0.2 mol % of coloring pigment and the cover layer contains 0.01 to 0.2 mol % of coloring pigment.

53. The method of claim 23, wherein the core and cover layer are both made of ceramic.

54. A method comprising:
providing a ceramic abutment of a two-part dental implant for receiving an element to be applied, the abutment comprising:
at least one core having an upper end, and
a cover layer that extends over said upper end of the at least one core,
the at least one core being configured to guarantee stability of the abutment while the cover layer is completely removable by grinding without loss of stability,
wherein the entire of the at least one core and the entire cover layer are visually different from one another as discerned visually by a naked eye, and
said core and cover layer are both made of ceramic;
the method comprising implanting the implant, including steps of:
inserting an implant base body of the two-part implant into a jaw bone of a patient,
grinding the cover layer of the abutment to correspond to the individual requirements of a patient, while visually observing the cover layer, and using the visually different core and cover layer as an integrated warning system to prevent further grinding that would no longer ensure stability of the core.
